(19) United States
(12) Patent Application Publication
(10) Pub. No.: US 2003/0225216 A1
(43) Pub. Date: Dec. 4, 2003

(54) Water dispersed resin composition for flocking

(76) Inventor: Mitsuo Satoh, Osaka (JP)

Correspondence Address: Ellen T. Dec, General Counsel, I.P., NATIONAL STARCH AND CHEMICAL COMPANY, 10 Finderne Avenue, Bridgewater, NJ, 08807-0500, US

(21) Appl. No.: 10/406,043

(22) Filed: Apr. 2, 2003

(30) Foreign Application Priority Data
Apr. 19, 2002 (JP) 2002-118014

(51) Int. Cl. C08L 67/02

(52) U.S. Cl. 525/165

(57) ABSTRACT

The present invention provides a water dispersed resin composition for flocking that is capable of flocking piles on polyolefin substrates without performing a primer treatment. The water dispersed resin composition has been improved in at least one property selected from the coatability of the resin composition, the adhesion between a coating formed therefrom and a substrate, the abrasion resistance of a flocked film formed therewith and the pile retention of the coating. The water dispersed resin composition for flocking comprises a resin composition comprising a copolymer obtained by polymerizing a monomer mixture comprising: component (A): CH₂═C(R¹)—COO—R², wherein R¹ is a hydrogen atom or a methyl group, R² is a monocyclic alkyl group; and other unsaturated monomers; and component (B): a resin composition of chlorinated polyolefin. It is preferable that the glass transition temperature of the copolymer contained in the component (A) is 10 to 60□, and that the viscosity of the water, dispersed resin composition for flocking is 100 to 5000 mPa□s.

### BACKGROUND OF THE INVENTION

1. Field of the Invention

The present invention relates to water dispersed resin compositions for flocking. In particular, the present invention relates to water dispersed resin compositions for flocking that are employed for flocking on polyolefin substrates for use in automobile upholsteries, automobile components such as glass channels, and the like.

2. Description of the Prior Art

For automobile upholsteries, ABS resin (acrylonitrile-butadiene-styrene resin) molded articles on which piles (short fibers) are flocked with acrylic emulsion adhesives have been used. Recently, however, molded articles using polyolefins as substrates have begun to be employed in place of ABS resin molded articles for purposes such as reducing the weight of car bodies and saving costs. Since acrylic emulsion adhesives are difficult to adhere to polyolefins, it is necessary to previously apply a primer (i.e., to perform a primer treatment) on molded articles using polyolefins as substrates and then to apply the acrylic emulsion adhesive thereon. Accordingly, the flocking on molded articles using polyolefins as the substrate requires a primer treatment and thus is extremely time and labor consuming, presenting the problem of higher costs as compared with the flocking on ABS resin molded articles. Moreover, for the purpose of cost saving, there is a demand in the automobile industry for useful adhesive compositions for flocking that can be applied also on polyolefin substrates without performing a primer treatment.

JP Kokai H1-153777 and JP Kokai H1-107869, for example, disclose adhesives that can be applied on polyolefin (particularly, polypropylene) substrates without performing a primer treatment. Here, although JP Kokai H1-153777 discloses an aqueous adhesive composition comprising an aqueous emulsion, it does not describe that the composition can be used in the field of flocking. JP Kokai H1-107869 discloses a flocking binder comprising chlorinated polypropylene that has been emulsified and dispersed and an acrylic emulsion. However, this flocking binder contains organic solvents such as toluene and xylene at about 15 wt % and is therefore not only harmful to the human body, but also undesirable from the viewpoint of environmental protection.

JP Kokai H5-287251 discloses a flocking adhesive containing no organic solvent, and describes that this flocking adhesive is preferable with regard to the human body and the environment and it can be used for polyolefin substrates without performing a primer treatment. However, this flocking adhesive is disadvantageous in that the adhesion between a coating (or film) formed with this adhesive and polyolefin substrates is insufficient. The use of this flocking adhesive to flock piles on polyolefin substrates presents the problem that the piles may not be retained for a long period (i.e., having poor pile retention). Therefore, there is a demand for aqueous flocking adhesives having high adhesion to polyolefin substrates, as well as being capable of forming coatings that can retain piles for a long period (i.e., having good pile retention).

JP Kokai H7-173347 and JP Kokoku H1-47309 disclose copolymer compositions that have been improved in adhesion by copolymerizing polyolefin resins with (meth)acrylic ester monomers and their derivatives. These copolymer compositions, however, were not sufficiently good in terms of the pile retention of coatings formed from the compositions. If a coating formed from compositions is designed to be hard in order to improve the pile retention, the coating may be too brittle. A coating that is too brittle is inferior in abrasion resistance, thereby possibly compromising appearance over the passage of time. Thus, it has been difficult to design compositions that are well balanced in various physical properties.

Further, JP Kokai H-7-173347 and JP Kokoku H1-47309 do not specifically disclose the favorable conditions for coating the compositions. Accordingly, with the compositions of the two publications, there is the possibility that coating defects occur when coating the compositions on polyolefin substrates. In order to improve the coatability of the compositions on polyolefin substrates, it is important to design the composition to be applied to the substrate appropriately. However, such designing is extremely difficult, and an inappropriate designing of the composition may result in problems such as insufficient or nonuniform coating thickness. If it is not possible to obtain an excellent coating, then the coating that is formed by flocking piles on a layer of the coated composition may not be able to retain the desired amount of piles. When the pile retention of the coating decreases, the adhesion between the substrate and the resulting coating and the abrasion resistance of a flocked coating formed therewith are also decreased.

### SUMMARY OF THE INVENTION

The present invention was made in order to solve the above-discussed problems and its object is to provide a water dispersed resin composition that can be used for flocking piles on substrates, and in particular on polyolefin substrates without performing a primer treatment. The water dispersed resin composition has been improved in at least one property selected from the coatability of the resin composition, the adhesion between the substrate and a coating formed therefrom, the abrasion resistance of a flocked coating formed therewith and the pile retention of the coating, and the water dispersed resin composition is well balanced in these properties.

The inventors found as the result of intensive research that a water dispersed resin composition comprising a copolymer obtained by polymerizing a monomer mixture comprising:

component (A): a monomer (a) represented by Formula (1):

CH₂═C(R¹)—COO—R² Formula (1)

wherein R¹ is a hydrogen atom or a methyl group, R² is a monocyclic alkyl group; and

other unsaturated monomers; and

component (B): a water dispersed resin composition of chlorinated polyolefin,

can be used as a water dispersed resin composition for flocking, particularly as a water dispersed resin composition for flocking that can be used for flocking on polyolefin substrates that have not been treated with a primer. The inventors also found that the resin composition has been improved at least one property selected from the coatability of the resin composition, the adhesion between a coating formed therefrom and a substrate, the abrasion resistance of a flocked coating formed therewith and the pile retention of the coating, and that it is well balanced in these properties.

In this specification, “water dispersed resin composition” refers to a composition in which a resin is dispersed (or suspended) in an aqueous medium, and it may also include a composition in which at least a portion of resin is dissolved in an aqueous medium. “Aqueous medium” refers to any kind of water, which includes distilled water, ion-exchange water and pure water. The “aqueous medium” may also include organic solvents, so long as the properties of the water dispersed resin composition according to the present invention are not adversely affected.

With the use of the water dispersed resin composition for flocking according to the present invention, it is possible to flock piles on a substrate, in particular on a polyolefin substrate without performing a primer treatment. Furthermore, the water dispersed resin composition has been improved in at least one property selected from the coatability on a substrate, the adhesion between a coating formed therefrom and a substrate, the abrasion resistance of a flocked coating formed therewith and the pile retention of a coating formed therefrom.

### DESCRIPTION OF THE PREFERRED EMBODIMENTS

The water dispersed resin composition, which is the component (A) according to the present invention, includes a copolymer obtained by polymerizing a monomer mixture comprising:

a specific monomer (a) represented by Formula (1):

CH₂═C(R¹)—COO—R² Formula (1)

wherein R¹ is a hydrogen atom or a methyl group, R² is a monocyclic alkyl group; and

other unsaturated monomers.

Monomer (a) may be any monomers represented by Formula (1), and there is no particular limitation.

In Formula (1), “monocyclic alkyl group” refers to a cyclic alkyl group having one ring, and it may also contain a substituent. The carbon number of R² is counted including the carbon number of the substituent. Examples of R² include a cyclohexyl group and a methylcyclopentyl group, but a cyclohexyl group is preferable. As the monomer (a), it is particularly preferable to use cyclohexyl (meth)acrylate.

It should be noted that in this specification, acrylic acid and methacrylic acid are also collectively referred to as “(meth)acrylic acid”, and acrylic acid ester and methacrylic acid ester are also collectively referred to as “(meth)acrylic acid ester” or “(meth)acrylate”.

“Other unsaturated monomers” refer to unsaturated monomers that are capable of copolymerizing with the monomer (a), and there is no particular limitation as long as a desired component (A) can be obtained. Examples of the other unsaturated monomers include the following monomers:

(meth)acrylic acid, maleic acid, maleic anhydride, acrylamide, methacrylamide, methyl (meth)acrylate, ethyl (meth)acrylate, isobutyl (meth)acrylate, n-butyl (meth)acrylate, 2-ethyl hexyl (meth)acrylate, dodecyl (meth)acrylate, stearyl (meth)acrylate, benzyl (meth)acrylate, glycidyl (meth)acrylate, styrene, methylstyrene, acrylonitrile and methacrylonitrile.

The weight ratio of “monomer (a)” to “other unsaturated monomers” (monomer (a)/other unsaturated monomers) contained in the monomer mixture is preferably 30/70 to 90/ 10, more preferably 40/60 to 80/20 and most preferably 50/50 to 70/30. When the ratio of monomer (a)/other unsaturated monomers is less than 30, the adhesion between an olefin substrate and a coating formed from the resin composition may be insufficient. When the weight ratio is more than 90, the pile retention of the coating may be insufficient. Accordingly, in order to obtain a water dispersed resin composition with excellent properties, it is preferable that the ratio monomer (a)/other unsaturated monomers is 30/70 to 90/10.

The component (A) can be produced by copolymerizing a monomer mixture containing the monomer (a) and the other unsaturated monomers in an aqueous medium in the presence of a catalyst and an emulsifier using an agitator capable of applying shearing forces.

Here, the types of “catalyst” and “emulsifier”, their concentrations, and polymerization reaction conditions such as reaction temperature, reaction time and agitation speed, may be suitably selected according to the desired properties of the water dispersed resin composition for flocking according to the present invention.

“Catalyst” refers to a compound that, when added in a small amount can cause the polymerization of a monomer mixture. A catalyst that can be used in an aqueous medium is preferable. Examples include ammonium persulfate, sodium persulfate, potassium persulfate, t-butylhydroperoxide, t-butylperoxybenzoate, 2,2-azobisisobutyronitrile, 2,2-azobis (2-diaminopropane)hydrochloride and 2,2-azobis(2,4-dimethyl)valeronitrile. It is particularly preferable to use ammonium persulfate, sodium persulfate and potassium persulfate.

In addition, a compound having a reducing effect that promotes the activity of the catalyst may be used as a promoter, together with the catalyst. Examples of such compounds include sodium thiosulfate and ferrous chloride.

“Emulsifier” refers to a surfactant that is used for forming an emulsion of an aqueous medium and a monomer mixture and that does not adversely affect the polymerization. As the emulsifier, it is preferable to use a compound having a sulfonic acid group, a compound having a sulfonate group, a compound having a sulfuric acid ester group or a mixture thereof. However, commonly used surfactants may also be used. Examples of such emulsifiers include the following compounds:

anionic surfactants such as soaps, alkyl sulfonic acid salts and polyoxyethylenealkyl sulfuric acid salts; and

nonionic surfactants such as polyoxyalkyl aryl ethers and oxyethylene-oxypropylene block copolymers.

It should be noted that it is more preferable to use a polymerizable emulsifier as the emulsifier. The use of a polymerizable emulsifier is preferable, because it improves, for example, the water resistance of a coating formed from resin compositions for flocking.

Here, “polymerizable emulsifier” refers to a compound having a polymerizable functional group and being capable of functioning as an emulsifier that can form an emulsion of an aqueous medium and a monomer mixture. Examples of such compounds include a compound having a sulfonic acid group, sulfonate group, sulfuric acid ester group or ethylene oxide group with an ethylene double bond between carbon atoms, and a mixture thereof. Additionally, as the counter cations of the sulfonic acid group or sulfonate group of the above-mentioned polymerizable emulsifier, ammonium ions, potassium ions and sodium ions are preferable.

The glass transition temperature of a copolymer (hereinafter also referred to as “copolymer Tg”) obtained by polymerizing the monomer mixture containing the monomer (a) and the other unsaturated monomers is preferably 10 to 60□, more preferably 20 to 40□ and most preferably 25 to 35□. A copolymer Tg of lower than 10□ results in an insufficient hardness of a coating formed from the resulting water dispersed resin composition for flocking, so that the strength of pile retention may become insufficient. On the other hand, a copolymer Tg of higher than 60□ renders a coating formed from the resulting water dispersed resin composition brittle, so that the abrasion resistance of a flocked coating formed on the coated layer of the composition may be reduced.

Since the copolymer contained in the component (A) is obtained by polymerizing a monomer mixture containing the monomer (a) and the “other unsaturated monomers”, the copolymer Tg is determined by the types of the monomer (a) and the “other unsaturated monomers” and the mixing ratio (part(s) by weight) of the monomer (a) to the “other unsaturated monomers”. In order to design a copolymer having a desired Tg, the mixing ratio of the monomer (a) to the “other unsaturated monomers” is determined in consideration of the glass transition temperature (hereinafter also referred to as “homopolymer Tg”) obtained by homopolymerizing the monomer (a) and each of the other unsaturated monomers contained in the monomer mixture.

Specifically, a “copolymer Tg” can be calculated by using Equation (2) for a theoretical copolymer Tg:

1/Tg=C₁/Tg₁+C₂/Tg₂+□□□+Cₙ/Tgₙ Equation (2)

wherein Tg is a theoretical copolymer Tg,

Cₙ is the weight ratio at which the n^{th} monomer “n” is contained in a monomer mixture, Tgₙ is the homopolymer Tg of the n^{th} monomer “n”,

n is the number of the monomers constituting the copolymer, and is a positive integer.

For the homopolymer Tg of monomers, values described in reference works may be employed. For example, the following reference works can be referred to: Acrylic Ester Catalog (1997 ed.) by Mitsubishi Rayon Co., Ltd; and Novel Polymer Library (Shin Kobunshi Bunko), vol. 7, Guide of Synthetic Resin for Paint (Toryo yo Goseijushi Nyumon) (Kyozo Kitaoka ed., published by Polymer Publishing Institute (Kobunsi Kankokai), 1997), pp. 168 to 169.

In the following, an example of design of the above-mentioned copolymer Tg will be described.

As the monomer (a), cyclohexyl (meth)acrylate (hereinafter also referred to as “CHMA”) having a homopolymer Tg of 83□ is used and the content ratio of the monomer in the monomer mixture is set at 40 to 67 parts by weight. In this case, as the “other unsaturated monomers”, for example, a monomer having a homopolymer Tg of 95□ or higher and a monomer having a homopolymer Tg of −50□ or lower are used and the content ratios of these monomers in the monomer mixture are set at 20 to 30 parts by weight for the former, and 13 to 30 parts by weight for the latter.

Specifically, 40 to 67 parts by weight of CHMA having a homopolymer Tg of 83□ are used as the monomer (a), and 20 to 30 parts by weight of methyl methacrylate (hereinafter also referred to as “MMA”, homopolymer Tg: 105□) and/or styrene (hereinafter also referred to as “St,” homopolymer Tg: 100□), which are monomers having a homopolymer Tg of 95□ or higher, and 13 to 30 parts by weight of 2-ethyl hexyl acrylate (hereinafter also referred to as “2HEA”, homopolymer Tg: −85□) and/or butyl acrylate (hereinafter also referred to as “BA”, homopolymer Tg: −54 □), which are monomers having a homopolymer Tg of −50□ or lower are used as the “other unsaturated monomers”. By polymerizing the mixture of these monomers, component (A) containing a copolymer with a theoretical Tg of 10 to 60□ can be obtained.

Examples of the “monomer (a)” include, in addition to CHMA, methylcyclopentylmethacrylate.

Examples of the “monomer having a homopolymer Tg of 95□” include, in addition to MMA and St, acrylamide (homopolymer Tg: 153□), acrylic acid (hereinafter also referred to as “AA”, homopolymer Tg: 106□), methacrylic acid (hereinafter also referred to as “MAA”, homopolymer Tg: 130 □), acrylonitrile (homopolymer Tg: 100□) and maleic acid (homopolymer Tg: 130□).

Examples of the “monomer having a homopolymer Tg of −50□ or lower” include, in addition to 2EHA and BA, dodecyl methacrylate (homopolymer Tg: −65□).

Additionally, for the value of homopolymer Tg of CHMA, the value described in Acrylic Ester Catalog (1997 ed.) by Mitsubishi Rayon Co., Ltd. was employed. For the values of Tg of MMA, St, 2EHA, BA, AA, MAA, acrylamide, acrylonitrile, maleic acid, dodecyl methacrylate, the values described in the following reference work were employed: Novel Polymer Library (Shin Kobunshi Bunko), vol. 7, Guide of Synthetic Resin for Paint (Toryo yo Goseijushi Nyumon) (Kyozo Kitaoka ed., published by Polymer Publishing Institute (Kobunsi Kankokai), 1997), pp. 168 to 169.

The component (B) of the water dispersed resin composition for flocking according to the present invention is a water dispersed resin composition of chlorinated polyolefin. Specific examples include water dispersed resin compositions of chlorinated polyethylene, chlorinated polypropylene, chlorinated polybutene, chlorinated isobutylene, a chlorinated product of an ethylene-propylene copolymer and a chlorinated product of a propylene-1-butene copolymer. The water dispersed resin composition of chlorinated polypropylene is particularly preferable. It should be noted that these can be used alone or in combination.

The component (B) can be obtained by chlorinating, in an organic solvent, a polyolefin such as polyethylene (including low density polyethylene and high density polyethylene), polypropylene (including crystalline polypropylene and amorphous polypropylene), polybutene, polyisobutylene, an ethylene-propylene copolymer, a propylene-1-butene copolymer, an ethylene-propylene-dien copolymer or an ethylene-vinyl acetate copolymer, followed by emulsifying with water and an emulsifier. It is preferable to remove the organic solvent thereafter. Here, the “emulsifier” is the same as described above.

As the component (B), commercially available water dispersed resin compositions of chlorinated polyolefin may be used. Examples include Superchlon E633™, Superchlon S-4032™ and Superchlon S-4044™ manufactured by Nippon Paper Industry and Hardlen EH202™ manufactured by Toyo Kasei Kogyo Co., Ltd.

The water dispersed resin composition for flocking according to the present invention comprises the above-described component (A) and component (B), and can be obtained by mixing the two components. At the time of mixing, it is preferable to add a viscosity modifier to modify the viscosity, as necessary. “Mixing” refers to any methods that are commonly used for mixing resin compositions, and there is no particular limitation as long as they can provide the water dispersed resin composition for flocking according to the present invention.

Additionally, “viscosity modifier” refers to modifiers that are commonly used to modify the viscosity of resin compositions, and there is no particular limitation so long as they can provide the water dispersed resin composition for flocking according to the present invention. However, it is preferable to use a viscosity modifier that can perform the modification with an amount that is as small as possible, so that the performance of the resin composition will not be affected. Example of the viscosity modifiers include alkali thickening-type modifiers such as Yodosol KA-10™ manufactured by Nippon NSC Ltd. and association-type modifiers such as Adekanol UH438 manufactured by Asahi Denka Co. Ltd.

Here, the solid content ratio ((A)/(B)) of the component (A) to the component (B) of the water dispersed resin composition for flocking is preferably 40 to 80/60 to 20, more preferably 45 to 70/55 to 30 and most preferably 50 to 60/50 to 40. When the component (A) is less than 40 parts by weight (i.e., when the component (B) is more than 60 parts by weight), the pile retention of a coating formed from the water dispersed resin composition for flocking and the abrasion resistance of a flocked coating formed on the coated layer of the water dispersed resin composition for flocking may decrease. When the component (A) is more than 80 parts by weight (i.e., when the component (B) is less than 20 parts by weight), the adhesion between a coating formed from the water dispersed resin composition for flocking and the substrate may decrease.

Here, “solid contents” of the component (A) and the component (B) refer to residues obtained by heating each of the component (A) and the component (B), which are water dispersed resin compositions, at 105□ for three hours.

Additionally, “concentration” of the component (A) and the “concentration” of the component (B) refer to the percentages of the mass (solid content) of the component (A) and the component (B) after they are heated at 105□ for three hours to obtain the above-described “solid contents”, with respect to the mass of the component (A) and the component (B) before they are heated.

The viscosity of the water dispersed resin composition for flocking according to the present invention obtained as above is preferably 100 to 5000 mPa□s, more preferably 1000 to 4000 mPa□s and most preferably 2000 to 3000 mPa□s, when measured by a SB type rotational viscometer (Spindle No. 4) at 30□. When the viscosity is less than 100 mPa□s, a coating, which is formed by coating the water dispersed resin composition for flocking on the substrate, may not have the desired thickness.

When the viscosity is more than 5000 mPa□s, the coatability of the water dispersed resin composition for flocking on the substrate may decrease. As is discussed below, examples of the methods of coating the water dispersed resin composition for flocking on a polyolefin substrate include a doctor knife coater, a roll coater and a spay coater. However, each of these coating methods may reduce the leveling properties of the coating, thereby possibly making it difficult to apply the water dispersed resin composition for flocking on the substrate in uniform thickness.

In this specification, “viscosity” refers to a value measured according to the “rotational viscometer method” described in JIS K5400. More specifically, it refers to a value measured by using a SB type rotational viscometer described in JIS K7117, which is a single cylinder rotational viscometer, as the “rotational viscometer” with spindle No. 4 and rotating the spindle at 60 rpm in the resin composition maintained at 30□.

The thixotropy index (hereinafter also referred to as “TI”) of the water dispersed resin composition for flocking according to the present invention is preferably 1.5 to 6.0, more preferably 1.8 to 4.0 and most preferably 2.0 to 3.0.

When the TI is less than 1.5, a coating formed from the resin composition may not have the desired thickness because of the high fluidity of the resin composition at the time of coating. On the other hand, when the TI is more than 6.0, the leveling properties of the coating are decreased and a coating of uniform thickness may not be obtained, because of the low fluidity of the resin composition at time of coating.

In this specification, “TI” refers to a value obtained by dividing a viscosity (hereinafter also referred to as “viscosity (6 rpm)”) measured by the same viscosity method as described above except for rotating the spindle at 6 rpm, by the above-described viscosity (hereinafter also referred to as “viscosity (60 rpm)”) measured when rotating the spindle at 60 rpm. Equation (3) for this TI is shown below.

TI=viscosity (6 rpm)/viscosity (60 rpm) Equation (3)

Although the above-described water dispersed resin composition for flocking can be directly used as a water dispersed resin composition (or as an adhesive) for flocking, for example, a disinfectant, antiseptic, antifoamer, plasticizer, fluidity adjusting agent, thickener, pH adjusting agent, surfactant, pigment, rust preventive, humectant, silane coupling agent or cross-linking agent may be added, as necessary.

The water dispersed resin composition for flocking according to the present invention is coated on a substrate, and piles are flocked on a layer of the coated composition at the same time with and/or after the application of the resin composition. Thereafter, the flocked layer of the composition becomes dry and a coating is formed.

The water dispersed resin composition for flocking can be coated by any method commonly used for coating resin compositions on substrates. For example, it can be coated on a polyolefin substrate by a spray coater, a doctor knife coater, a roll coater or a wire coater.

The coating amount in terms of solid content of the water dispersed resin composition for flocking on a substrate is preferably 10 to 200 g/m², more preferably 30 to 150 g/m² and most preferably 40 to 100 g/m².

As the method for flocking on a substrate on which the water dispersed resin composition for flocking according to the present invention is coated, it is possible to use any methods that are commonly used for flocking on substrates without any particular limitation. Examples of such methods include spray coating the resin composition together with piles and electrostatic flocking. Spray coating the resin composition together with piles allows the plies to easily penetrate into an adhesive layer, thereby making it possible to decrease the coating amount of the adhesive. On the other hand, the use of electrostatic flocking is preferable in that individual piles stand erect and adhere to an adhesive coating (coated layer) on the surface to which they are flocked, without any gaps therebetween.

Here, “substrate” may be any commonly used substrate on which the resin composition for flocking can be coated and piles can be flocked, and there is no particular limitation. Examples of “substrate” include plastic substrates, such as polyolefin substrates and ABS resin substrates, and fiber substrates. The water dispersed resin composition for flocking according to the present invention can also preferably be used for polyolefin substrates that have not been treated with a primer. “Polyolefin substrates” refer to substrates manufactured using resins that are commonly called polyolefins. Examples include substrates obtained by processing polyolefins, such as polyethylenes, polypropylenes and ethylene-propylene copolymers, into molded articles. Further examples include polyolefin substrates blended with fillers, such as glass fibers, calcium carbonate and talc, as well as polyolefin substrates modified with polymers, such as polycarbonate, polystyrene, acrylonitrile-styrene copolymers, polymethyl methacrylate, polyphenylene oxide, nylon, polyester, ABS resins and rubbers.

“Piles” may be any commonly used piles, and there is no particular limitation. Examples of piles include the following:

natural fibers such as cotton, wool and hemp;

wool fibers such as rayon and protein fibers;

synthetic fibers such as polyurethane fibers, polyvinyl chloride fibers, polyvinyl alcohol fibers, polyvinylidene chloride fibers, polyester fibers, polyamide (nylon) fibers, acrylonitrile polymer fibers and acrylonitrile copolymer fibers and polyolefin fibers; and

textiles products obtained by blending the above-mentioned fibers, such as woven fabrics and nonwoven fabrics.

The water dispersed resin composition for flocking according to the present invention has been improved in at least one property selected from the coatability, the adhesion of a coating formed therefrom to a substrate, the abrasion resistance of a flocked coating formed therewith and the pile retention of the coating, and it is well balanced in these properties.

In this specification, “coatability” means the ability of a composition to be generally evenly coated on the substrate in uniform thickness. More specifically, it refers to the ease of spraying when spray coating the water dispersed resin composition for flocking on a polyolefin substrate. Whether or not the composition is generally evenly coated in uniform thickness is evaluated by visual inspection.

It is preferable that the water dispersed resin composition for flocking according to the present invention can be coated generally evenly on a polyolefin substrate in uniform thickness by spray coating (that is, evaluated as “A” or “B”, i.e., as having good coatability in the working examples).

In this specification, “adhesion (or adhesiveness)” refers to the adhesion between a coating and a polyolefin substrate, measured by a crosscut tape test according to JIS K5400. Specifically, a series of cross cuts at right angles to each other were made on a coating formed on a test piece such that they penetrated the coating and reached the surface of the polyolefin substrate. After an adhesive tape is applied to the cross cuts and then peeled off, the adhesion condition of the coating is evaluated by visual inspection. Since the adhesion test focused on the adhesion between the substrate and the coating, the test employed a coating that had been formed by coating the water dispersed resin composition on the substrate, followed by drying the coated layer of the composition without flocking (without performing pile treatment) thereon. In this evaluation test according to JIS K5400, the evaluation is expressed numerically with a score of 0 to 10. The higher the evaluation, the higher the score is, and the highest score is 10.

It is preferable that the adhesion evaluation score of a coating formed from the water dispersed resin composition for flocking according to the present invention is 8 to 10 (that is, evaluated as “A” and “B”, i.e., as having excellent adhesion in the working examples).

In this specification, “abrasion resistance” refers to the abrasion resistance of a flocked coating, measured by a Taber type method according to JIS L1096. Specifically, a disc-shaped test piece was produced from polyolefin, and the water dispersed resin composition for flocking according to the present invention was applied to the surface of the disc-shaped test piece. Then, the resulting layer of the composition was flocked, followed by drying the composition layer, thereby obtaining a coating. Thereafter, the disc-shaped test piece was placed in a Taber type abrasion tester and was abraded 1000 times with application of a load of 500 g while being rotated at 70 rpm, whereupon the change in appearance of the test piece was evaluated by visual inspection.

It is preferable that in the water dispersed resin composition for flocking according to the present invention, no abnormality is observed in the appearance of the abraded portion of the flocked coat on the test piece (that is, evaluated as “A” or “B”, i.e., as having excellent abrasion resistance in the working examples).

Furthermore, a substrate that is flocked using the water dispersed resin compositions for flocking according to the present invention is provided. In particular, a flocked polyolefin substrate is provided.

### WORKING EXAMPLES

Hereinafter, the present invention will be described more specifically and in detail by way of working examples and comparative examples. However, these working examples are only embodiments of the invention, and do not limit the present invention in any way.

The monomers that were used to obtain the component (A) of the working examples are listed below:

cyclohexyl methacrylate (hereinafter also referred to as “CHMA”);

styrene (hereinafter also referred to as “St”);

2-ethyl hexyl acrylate (hereinafter also referred to as “2EHA”); and

methacrylic acid (hereinafter also referred to as “MAA”).

The “glass transition temperature (Tg) of copolymer” contained in the component (A) was calculated by using Equation (2) for theoretical copolymer Tg.

1/Tg =C₁/Tg₁+C₂/Tg₂+□□□+Cₙ/Tgₙ Equation (2)

wherein Tg is a theoretical copolymer Tg,

Cₙ is the weight ratio at which the n^{th} monomer “n” is contained in a monomer mixture, Tgₙ is a homopolymer Tg of the n^{th} monomer “n”,

n is the number of monomers constituting the copolymer, and is a positive integer.

As the above-described homopolymer Tg of monomer, the values described in reference works were employed.

The value described in Acrylic Ester Catalog (1997 ed.) by Mitsubishi Rayon Co., Ltd was used for CHMA, and the values described in Novel Polymer Library (Shin Kobunshi Bunko), vol. 7, Guide of Synthetic Resin for Paint (Toryo yo Goseijushi Nyumon) (Kyozo Kitaoka ed., published by Polymer Publishing Institute (Kobunsi Kankokai), 1997), pp. 168 to 169., were used for St, 2EHA and MMA. The values of homopolymer Tg for CHMA, St, 2EHA and MAA were 83□, 100□, −85□ and 130□, respectively.

The “solid contents” of the component (A) and the component (B) were obtained by heating the component (A) and the component (B), which were water dispersed resin compositions, at 105□ for three hours.

At the time of obtaining the above-described “solid contents”, the “concentraton” of the component (A) and the “concentration” of the component (B) were determined as the percentages of the mass (solid content) of the component (A) and the component (B) after they were heated at 105□ for three hours, with repsect to the mass of the component (A) and the component (B) before they were heated.

The viscosity measurement of the water dispersed resin compositions for flocking was conducted according to the “rotational viscometer method” described in JIS K5400, using a rotational viscometer, a container, a thermometer and a constant temperature bath. As the “rotational viscometer”, a SB type rotational viscometer prescribed in JIS K7117, which was a single cylinder rotational viscometer, was used with spindle No. 4. As the “constant temperature bath,” one capable of setting the water temperature at approximately 30□ was used.

In the resin composition held in a container maintained at 30□ with the constant temperature bath, the spindle was rotated at 60 rpm and the delay in rotation of the rotor caused by the resistance of the resin compositions was marked on a scale, thereby determining the viscosity.

The viscosity of the component (A) was measured in the same manner as the above-described viscosity measurement of the resin composition.

The TI of the water dispersed resin composition for flocking was determined by dividing a viscosity (hereinafter also referred to as “viscosity (6 rpm)”) obtained in the same manner as the above-described viscosity measurement except for rotating the spindle at 6 rpm, by a viscosity (hereinafter also referred to as “viscosity (60 rpm)”) obtained by rotating the above-mentioned spindle at 60 rpm. Equation (3) for the TI is shown below.

TI=viscosity (6 rpm)/viscosity (60 rpm) Equation (3)

The resulting water dispersed resin composition for flocking was evaluated for the coatability of the resin composition, the adhesion between a coating formed therefrom and the substrate, and the abrasion resistance of a flocked coating formed therewith.

The coatability of the resin composition was evaluated by testing the ease of spraying when spraying the resin compositions onto a polyolefin substrate. The evaluation criteria for the “coatability” were as follows.

“A” indicates that the composition was generally evenly coated on the substrate in uniform thickness);

“B” indicates that the composition was generally evenly coated in substantially uniform thickness; and

“C” indicates that the composition was generally unevenly coated on the substrate in nonuniform thickness, or that the thickness of the coating did not reach the desired thickness.

The adhesion between the coating formed from the water dispersed resin composition for flocking and the substrate was evaluated by performing a crosscut test according to the crosscut tape method described in JIS K5400. Specifically, a series of cross cuts at right angles to each other were made on a coating formed on a test piece such that they penetrated and reached the surface of the polyolefin substrate, and an adhesive tape was applied to the cuts. After the tape was peeled off, the adhesion condition of the coating was evaluated by visual inspection. The evaluation criteria were as follows:

“A” indicates that no detachment of the coating was observed even at the intersections of the cuts (corresponding to an evaluation score of 10);

“B” indicates that the coating slightly flaked (less than 5%) along the edges of the cuts and at the intersections of the cuts, but did not completely flaked off (corresponding to an evaluation point of 8);

“C” indicates that the coating flaked off (less than 35%) partly or completely along the edges of the cuts (corresponding to an evaluation score of 6 or 4); and

“D” indicates that a significantly great detachment (at least 35%) of the coating was observed (corresponding to an evaluation score of 2 or 0).

The abrasion resistance of the flaked coating formed from the water resin composition for flocking was evaluated by performing an abrasion resistance test using a Taber type method according to JIS L1096. Specifically, a disc-shaped test piece was produced from polyolefin, and the resin composition was coated on the surface of the disc-shaped test piece. Then, the resulting composition layer was flocked by electrostatic flocking, followed by drying the composition layer, thereby obtaining a coating. The disc-shaped test piece having this flocked coating was placed on a Taber type abrasion tester and was abraded 1000 times with application of a load of 500 g while being rotated at 70 rpm, whereupon the change in appearance of the test piece was evaluated by visual inspection.

Production of Water Dispersed Resin Composition for Flocking of Working Example 1

160 parts by weight of water and 0.5 parts by weight of Aqualon HS10™ manufactured by Sanyo Kasei Co., Ltd. were charged in a reactor provided with an agitator, a condenser and a thermometer. After replacing the atmosphere of the system by nitrogen gas, the resulting mixture was heated to 80□.

Meanwhile, a homogeneous solution of a separately prepared monomer mixture (theoretical Tg of the resulting copolymer: 32□) was added to a homogeneous solution comprising 40 parts by weight of water and 2.5 parts by weight of Aqualon HS10, and the whole was stirred with the agitator, thereby preparing a pre-emulsion.

Here, the monomers constituting the above-described monomer mixture were as follows:

cyclohexyl methacrylate: 60 parts by weight;

styrene: 20 parts by weight;

2-ethyl hexyl acrylate: 19 parts by weight; and

methacrylic acid: 1 part by weight

Further, an aqueous solution in which 1 part by weight of potassium persulfate (hereinafter also referred to as “KPS”) as a polymerization catalyst was dissolved in 40 parts by weight of water was prepared.

The above-mentioned pre-emulsion and aqueous solution of KPS serving as the polymerization catalyst were concurrently added dropwise over three hours into the above-described reactor of which atmosphere had been replaced by nitrogen gas, with the temperature inside the reactor maintained at 80□. The solution was continuously stirred at 80□ for another three hours to obtain a resin emulsion of the component (A).

The resulting resin emulsion of the component (A) had a viscosity of 40 mPa□s and a concentration of 30 wt %.

To 344 parts by weight in terms of solid content of the above-described composition as the component (A), 344 parts by weight in terms of solid content of a dispersion of chlorinated polyolefin, that is, Superchlon E633™ manufactured by Nippon Paper Industry were added as the component (B), to which Yodosol KA-10™ manufactured by Nippon NSC Ltd. was further added as a viscosity modifier to modify the viscosity and the thixotropy index (hereinafter also referred to as “TI”), thereby obtaining a water dispersed resin composition for flocking of Working Example 1. The composition had a viscosity of 4000 mPa□s and a TI of 4.1. The evaluation results are shown in Table 1.

Production of Water Dispersed Resin Composition for Flocking of Working Example 2

A water dispersed resin composition for flocking of Working Example 2 was produced in the same manner as in Working Example 1, except that 86 parts by weight in terms of solid content of Superchlon E633 were added as the component (B), to which Yodosol KA-10™ was further added as a viscosity modifier to modify the viscosity and the TI. Here, the composition of Working Example 2 had a viscosity of 3500 mPa□s and a TI of 3.5.

Production of Water Dispersed Resin Composition for Flocking of Working Example 3

A water dispersed resin composition for flocking of Working Example 3 was produced in the same manner as in Example 1, except that 516 parts by weight in terms of solid content of Superchlon E633 were added as the component (B), to which Yodosol KA-10 was further added as a viscosity modifier to modify the viscosity and the TI. Here, the composition of Working Example 3 had a viscosity of 4100 mPa□S and a TI of 4.5.

Production of Water Dispersed Resin Composition for Flocking of Working Example 4

The monomer mixture was changed to a mixture (theoretical Tg of the resulting copolymer: 47□) comprising the following monomers:

cyclohexyl methacrylate: 60 parts by weight;

styrene: 25 parts by weight;

2-ethyl hexyl acrylate: 14 parts by weight; and

methacrylic acid: 1 part by weight

The resulting resin emulsion was used as the component (A).

The resin emulsion serving as the component (A) had a viscosity of 40 mPa□S and a concentration of 30%.

A water dispersed resin composition for flocking of Working Example 4 was produced in the same manner as in Working Example 1, except that 344 parts by weight in terms of solid content of this component (A) were used, and 344 parts by weight in terms of solid content of Superchlon E633 were added as the component (B), to which Yodosol KA-10 was further added as a viscosity modifier to modify the viscosity and the TI. Here, the composition of Working Example 4 had a viscosity of 4000 mPa□s and a TI of 3.9.

Production of Water Dispersed Resin Composition for Flocking of Working Example 5

A water dispersed resin composition for flocking of Working Example 5 was produced in the same manner as in Working Example 1, except that the added amount of Yodosol KA-10 as a viscosity modifier was changed to modify the viscosity and the TI. Here, the composition of Working Example 5 had a viscosity of 500 mPa□s and a TI of 3.2.

Production of Water Dispersed Resin Composition for Flocking of Working Example 6

A water dispersed resin composition for flocking of Working Example 6 was produced in the same manner as in Working Example 1, except that the added amount of Yodosol KA-10 as a viscosity modifier was changed to modify the viscosity and the TI. Here, the composition of Working Example 6 had a viscosity of 4500 mPa□s and a TI of 4.5.

Production of Water Dispersed Resin Composition for Flocking of Comparative Example 1

A water dispersed resin composition for flocking of Comparative Example 1 was produced in the same manner as in Working Example 1, except that the component (B) was not used. Here, the composition of Comparative Example 1 had a viscosity of 4000 mPa□s and a TI of 3.9.

Production of Water Dispersed Resin Composition for Flocking of Comparative Example 2

A water dispersed resin composition for flocking of Comparative Example 2 was produced in the same manner as in Working Example 1, except that the component (A) was not used. Here, the composition of Comparative Example 2 had a viscosity of 3600 mPa□s and a TI of 3.5.

Production of Water Dispersed Resin Composition for Flocking of Comparative Example 3

The monomer mixture was changed to a mixture (theoretical Tg of the resulting copolymer:−9□) comprising the following monomers:

cyclohexyl methacrylate: 60 parts by weight;

2-ethyl hexyl acrylate: 39 parts by weight; and

methacrylic acid: 1 parts by weight

The resulting resin monomer was used as the component (A).

This resin emulsion serving as the component (A) had a viscosity of 35 mPa□s and a concentration of 30%.

A water dispersed resin composition for flocking of Comparative Example 3 was produced in the same manner as in Working Example 1, except that 344 parts by weight in terms of solid content of this component (A) were used, and 344 parts by weight in terms of solid content of Superchlon E633 were added as the component (B), to which Yodosol KA-10 was further added as a viscosity modifier to modify the viscosity and the TI. Here, the composition of Comparative Example 3 had a viscosity of 3900 mPa□S and a TI of 3.8.

Production of Water Dispersed Resin Composition for Flocking of Comparative Example 4

The monomer mixture was changed to a mixture (theoretical Tg of the resulting copolymer: 73□) comprising the following monomers:

cyclohexyl methacrylate: 60 parts by weight;

styrene: 34 parts by weight;

2-ethyl hexyl acrylate: 5 parts by weight; and

methacrylic acid: 1 part by weight.

The resulting resin emulsion was used as the component (A)

This resin emulsion serving as the component (A) had a viscosity of 40 mPa□s and a concentration of 30%.

A water dispersed resin composition for flocking of Comparative Example 4 was produced in the same manner as in Working Example 1, except that 344 parts by weight in terms of solid content of this component (A) were used, and 344 parts by weight in terms of solid content of Superchlon E633 were added as the component (B), to which Yodosol KA-10 was further added as a viscosity modifier to modify the viscosity and the TI. Here, the composition of Comparative Example 4 had a viscosity of 4000 mPa□s and a TI of 3.8.

Production of Water Dispersed Resin Composition for flocking of Comparative Example 5

A water dispersed resin composition for flocking of Comparative Example 5 was produced in the same manner as in Working Example 1, except that the added amount of Yodosol KA-10 as a viscosity modifier was changed to modify the viscosity and the TI. Here, the composition of Comparative Example 5 had a viscosity of 50 mPa□s and a TI of 2.0.

Production of Water Dispersed Resin Composition for Flocking of Comparative Example 6

A water dispersed resin composition for flocking of Comparative Example 6 was produced in the same manner as in Working Example 1, except that the added amount of Yodosol KA-10 as a viscosity modifier was changed to modify the viscosity and the TI. Here, the composition of Comparative Example 6 had a viscosity of 10,000 mPa□s and a TI of 6.5.

The water dispersed resin compositions of Working Examples 1 to 6 and the water dispersed resin compositions of Comparative Examples 1 to 6 were examined for the above-described coatability, adhesion and abrasion resistance. The results are shown in Tables 1 and 2.

TABLE 1

| | Working Examples | | | | | |
|---|---|---|---|---|---|---|
| | 1 | 2 | 3 | 4 | 5 | 6 |
| Component (A) | | | | | | |
| Monomer^{a)} | | | | | | |
| CHMA | 60 | 60 | 60 | 60 | 60 | 60 |
| St | 20 | 20 | 20 | 25 | 20 | 20 |
| 2EHA | 19 | 19 | 19 | 14 | 19 | 19 |
| MAA | 1 | 1 | 1 | 1 | 1 | 1 |
| Tg^{b)} | 32 | 32 | 32 | 47 | 32 | 32 |
| Composition for | | | | | | |
| flocking | | | | | | |
| (A)/(B)^{c)} | 50/50 | 80/20 | 40/60 | 50/50 | 50/50 | 50/50 |
| Viscosity^{d)} | 4000 | 3500 | 4100 | 4000 | 500 | 4500 |
| TI^{e)} | 4.1 | 3.5 | 4.5 | 3.9 | 3.2 | 4.5 |
| Coatability | B | A | B | B | A | B |
| Adhesion | B | B | A | B | B | B |
| Abrasion | B | A | B | B | B | B |
| resistance | | | | | | |

^{a)}The monomers contained in the monomer mixture and their amounts (parts by weight)
^{b)}The glass transition temperature (□) of the copolymer
^{c)}The weight ratio of the component (A) to the component (B)
^{d)}The viscosity (mPa□s) at 30□
^{e)}The TI at 30□

TABLE 2

| | Comparative Examples | | | | | |
|---|---|---|---|---|---|---|
| | 1 | 2 | 3 | 4 | 5 | 6 |
| Component (A) | | | | | | |
| Monomer^{a)} | | | | | | |
| CHMA | 60 | | 60 | 60 | 60 | 60 |
| St | 20 | | | 34 | 20 | 20 |
| 2EHA | 19 | | 39 | 5 | 19 | 19 |
| MAA | 1 | | 1 | 1 | 1 | 1 |
| Tg^{b)} | 32 | | −9 | 73 | 32 | 32 |
| Composition for | | | | | | |
| flocking | | | | | | |
| (A)/(B)^{c)} | 100/0 | 0/100 | 50/50 | 50/50 | 50/50 | 50/50 |
| Viscosity^{d)} | 4000 | 3600 | 3900 | 4000 | 50 | 10000 |
| TI^{e)} | 3.9 | 3.5 | 3.8 | 3.8 | 2.0 | 6.5 |
| Coatability | B | A | B | B | C | C |
| Adhesion | D | B | C | A | D | D |
| Abrasion | C | C | C | C | C | C |
| resistance | | | | | | |

^{a)}The monomers contained in the monomer mixture and their amounts (parts by weight).
^{b)}The glass transition temperature (□) of the copolymer
^{c)}The weight ratio of the component (A) to the component (B)
^{d)}The viscosity (mPa□s) at 30□
^{e)}The TI at 30□

What is claimed is:

1. A water dispersed resin composition for flocking, comprising:
a water dispersed resin composition comprising a copolymer obtained by polymerizing a monomer mixture comprising:
component (A): a monomer (a) represented by Formula (1):
CH₂═C(R¹)—COO—R² Formula (1)
wherein R¹ is a hydrogen atom or a methyl group, R² is a monocyclic alkyl group; and
other unsaturated monomers; and
component (B): a water dispersed resin composition of chlorinated polyolefin.

2. The water dispersed resin composition for flocking according to claim 1, wherein the solid content ratio ((A)/(B)) of the component (A) to the component (B) is 40 to 80 parts by weight/60 to 20 parts by weight.

3. The water dispersed resin composition for flocking according to claim 1 or 2, wherein the monomer (a) represented by Formula (1) is cyclohexyl (meth)acrylate

4. The water dispersed resin composition for flocking according to any one of claims 1 to 3, wherein the glass transition temperature of the copolymer obtained by polymerizing the monomer mixture containing the monomer (a) and the other unsaturated monomers contained in the component (A) is 10 to 60□.

5. The water dispersed resin composition for flocking according to any one of claims 1 to 4,
wherein the viscosity of the water dispersed resin composition for flocking is 100 to 5000 mPa□s when measured by a SB type rotational viscometer (Spindle No. 4) at 30□ and
wherein the thixotropy index of the water dispersed resin composition for flocking is 1.5 to 6.0 when measured by a SB type rotational viscometer (Spindle No. 4) at 30□.

6. The water dispersed resin composition for flocking according to any one of claims 1 to 5, wherein the component (B) is a water dispersed resin composition of chlorinated polypropylene.

7. The water dispersed resin composition for flocking according to any one of claims 1 to 6, wherein no abnormality is observed when the resin composition is coated on a test piece in a Taber type abrasion tester, and a flocked coating formed therefrom is abraded 1000 times while applying a load of 500 g, followed by observation of the appearance of an abraded portion of the test piece.

8. The water dispersed resin composition for flocking according to any one claims 1 to 7, wherein the adhesion evaluation score of a coating formed therefrom is 8 to 10 when measured by a crosscut tape method.

9. The water dispersed resin composition for flocking according to any one of claims 1 to 8, wherein the resin composition can be uniformly spray coated together with piles on a polyolefin substrate.

10. A polyolefin substrate that is flocked using the water dispersed resin composition for flocking according to any one of claims 1 to 9.
